(19) United States
(12) Patent Application Publication
(10) Pub. No.: US 2009/0220194 A1
(43) Pub. Date: Sep. 3, 2009

(54) PLASMONIC ANTENNA FEED AND COUPLING METHOD AND DEVICE

(75) Inventors: Brett A. Williams, Iowa City, IA (US); Kurt S. Schuder, Dallas, TX (US)

Correspondence Address: BUCHANAN, INGERSOLL & ROONEY PC, POST OFFICE BOX 1404, ALEXANDRIA, VA, 22313-1404, US

(73) Assignee: Lockheed Martin Corporation, Bethesda, MD (US)

(21) Appl. No.: 12/389,348

(22) Filed: Feb. 19, 2009

Related U.S. Application Data
(60) Provisional application No. 61/029,692, filed on Feb. 19, 2008.

(51) Int. Cl. G02B 6/26

(52) U.S. Cl. 385/30

(57) ABSTRACT

A plasmonic antenna feed and coupling device is disclosed that can include an antenna and a waveguide operatively coupled to the antenna. Surface plasmon polaritons generated on a surface of the antenna can be guided in a plasmonic state from the antenna through the waveguide. A method of plasmonic field guidance can include generating surface plasmon polaritons on a surface of an antenna, guiding the surface plasmon polaritons in a plasmonic state from the antenna to a waveguide and coupling the surface plasmon polaritons in a plasmonic state to a port.

### CROSS-REFERENCE TO RELATED APPLICATIONS

This application claims priority from U.S. Provisional Patent Application Ser. No. 61/029,692, filed Feb. 19, 2008, the disclosure of which is hereby incorporated by reference in its entirety.

### BACKGROUND

1. Field

Plasmonic antenna feed and coupling method and device are disclosed wherein polaritons generated on a surface of the antenna can be guided in a plasmonic state from an antenna through a waveguide.

2. Description of Related Art

Surface plasmon polaritons, also referred to herein as “SPPs,” are surface plasmons that can be associated with incident light waves that result when free space electromagnetic waves couple to free electron oscillations (surface plasmons) in a conductor, usually a metal or semiconductor. Surface plasmon polaritons are lightwaves trapped on a conductive surface due to their interactions with electrons on the conductive surface.

Metals and semiconductors can support collective surface oscillations of free electrons. These collective surface oscillations can concentrate electromagnetic fields on the nanoscale, enhancing local field strength in a particular direction by several orders of magnitude. Plasmon characteristics can be accessed at optical and radio wavelengths. Normal propagating electromagnetic (EM) waves can have constant phase and amplitude in the same plane. Surface plasmons and surface plasmon polaritons can have planes of constant phase perpendicular to those of constant amplitude, i.e. both are forms of evanescent waves.

The primary responders to EM waves are electrons followed by polar molecules. Even low inertia electrons can fail to keep up with high frequencies depending on material used in constructing a detector. The dependence on the material used can be described by the index of refraction (or dielectric constant or relative permittivity) and can be a function of EM frequency.

This dependence on index of refraction and on frequency (or wavelength) is called a “dispersion relation.” Surface plasmons on a smooth planar metal can display non-radiative electromagnetic modes, i.e., the surface plasmons cannot decay spontaneously into photons nor can light be coupled directly with surface plasmons.

The reason for this non-radiative nature of surface plasmons is that interaction between light and surface plasmons cannot simultaneously satisfy energy and momentum conservation; the conservation of parallel momentum is not satisfied as represented by the momentum wave-vector, k (where the magnitude of k=2π/λ, with λ being the EM wavelength). When surface plasmons and light are made to be in resonance, the result is a surface plasmon polariton. The surface plasmon polariton is an electromagnetic field in which both light and electron wave distributions match in their momentum vector, i.e. they have the same wavelength. This is also true for non-optical EM energy, e.g., radio waves.

Resonance and field enhancement can be made to take place if the electromagnetic momentum wave vector is increased, as in a transparent medium with an index of refraction, n, to match incident EM energy to the surface plasmon momentum wave-vector, or inversely, resonance can be achieved by imposing a surface impedance, i.e., along a dielectric/metal interface, in order to match free space electromagnetic waves to surface plasmons. In known systems, momentum issues can be circumvented, either by a prism coupling technique to shorten the electromagnetic wavelength, or by a metal surface grating, nanostructures such as holes, dimples, posts or statically rough surfaces, for example. This resonance can result in the fields associated with moving electron collections enhancing that of electromagnetic waves at the matched wavelength.

There are a number of known ways in which to create surface plasmon polaritons, for example, the Kretchmann-Rather attenuated total reflection configuration comprised of a dielectric prism mated with a thin metal film. For the Kretchmann-Rather configuration, a plasmon does not ride on the dielectric/metal interface. Plasmons arise instead on the back, metal/air interface. Once EM waves incident on the dielectric/metal interface exceed the so-called critical angle of total internal reflection, they can establish evanescent waves that penetrate a metal film to some skin depth. Such light-induced evanescent waves can excite surface plasmon polaritons on the side of the metal opposite the dielectric.

An example of a known plasmonic antenna that uses surface plasmon polaritons is described in U.S. patent application Ser. No. 11/589,937 titled “Method and Apparatus for Detecting EM Energy Using Surface Plasmon Polaritons,” and which is incorporated herein by reference. Such a device can allow radio frequency (RF) transmission over a specified field-of-view (FOV) while rejecting other incident signals by virtue of k-vector mismatching, a characteristic of surface plasmon polaritons. In known devices, polariton quanta generated on a semiconductor surface can be converted to the RF wave state by a surface grating, coupled to a traditional RF feed line and guided to their destination. However, RF emissions from polaritons close to the grating surface can create near-field phenomena that can involve complex phased structures with excess destructive interference, which may even change over the field-of-view.

Additionally, although a grating coupling mechanism can be enhanced by the number of grating periods and other factors, this can be limited by short antenna lengths allowed by, for example, a radome associated with a miniature missile seeker.

### SUMMARY

In an exemplary embodiment, a plasmonic antenna feed and coupling device can include an antenna and a waveguide operatively coupled to the antenna. Surface plasmon polaritons generated on a surface of the antenna are guided in a plasmonic state from the antenna through the waveguide.

In an exemplary embodiment, a plasmonic waveform can be converted, e.g., through a metallic/semiconductor taper, to RF waves on a standard microstrip RF line, e.g., waveguide.

In an exemplary embodiment, there may not be a transition to the RF state, but rather a direct coupling to a device, e.g., microdisk resonator, that initiates plasmonic waveforms on the device itself without conversion to RF waves.

In another exemplary embodiment, a method of plasmonic field guidance can include generating surface plasmon polaritons on a surface of an antenna, guiding the surface plasmon polaritons in a plasmonic state from the antenna to a waveguide and coupling the surface plasmon polaritons in a plasmonic state to a port.

### BRIEF DESCRIPTION OF THE DRAWINGS

Those skilled in the art will realize that different embodiments are possible, and the details disclosed herein are capable of modification in various respects, all without departing from the scope of the claims. Accordingly, the drawings and descriptions are to be regarded as illustrative in nature and not as restrictive. Like reference numerals have been used to designate like elements.

FIGS. 1A, 1B and 1C show exemplary embodiments of a plasmonic antenna feed and coupling device.

FIG. 2 shows an exemplary polariton waveguide formulation method.

FIG. 3 shows an exemplary plasmonic waveguide cross-section.

FIG. 4 shows an exemplary end view of a plasmonic waveguide.

### DETAILED DESCRIPTION

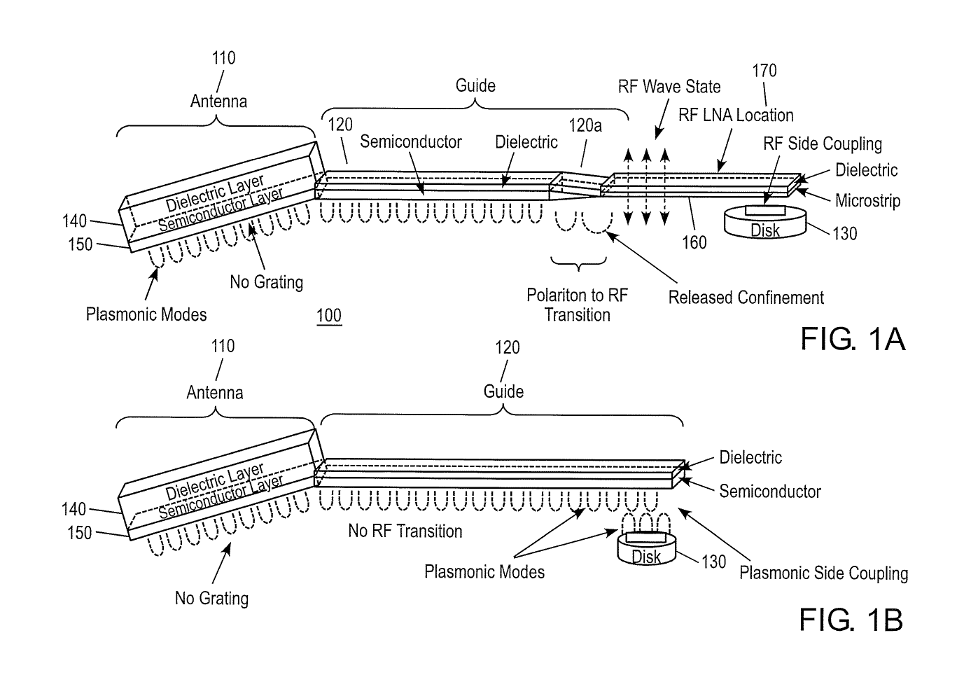

Common elements of the exemplary embodiments of plasmonic antenna feed and coupling device 100 shown in FIGS. 1A, 1B and 1C can include an antenna 110 and a waveguide 120 operatively coupled to the antenna 110. Polaritons generated on a surface of the antenna 110 can be guided in a plasmonic state from the antenna 110 through the waveguide 120. A microdisk radio frequency resonator 130, for example, can be operatively coupled to the waveguide 120.

An exemplary method of plasmonic field guidance can include generating polaritons on a surface of an antenna 110, guiding the polaritons in a plasmonic state from the antenna 110 to a waveguide 120 and coupling the polaritons in a plasmonic state to a port, e.g., a microdisk radio frequency resonator 130.

In exemplary embodiments, antenna 110 and waveguide 120 can include dielectric layer 140 for receiving incident EM energy and semiconductor layer 150. In a non-limiting example, the dielectric layer 140 and semiconductor layer 150 can be arranged one on top of another.

In an embodiment, surface features can be imposed on any surface of the antenna and plasmonic waveguide, whether in metallic or dielectric materials. For example, grating surfaces on the front and/or back of the dielectric layer can enhance response of the plasmon state.

The semiconductor layer 150 can be adjacent to the dielectric layer 140, e.g., in direct contact, or in sufficiently close proximity as to function in accordance with the objectives described herein. Polaritons as employed by this application may propagate in semiconductor materials and doped semiconductor materials as long as their charge density results in a plasma frequency preferably at least \sqrt{2} times that of the incident frequency of interest, thus resulting in a permitivitty real part less than negative one.

Intrinsic semiconductors, such as germanium, can provide change densities high enough that a negative index can be satisfied below 10 GHz radio frequencies, while doped materials, e.g., 4H—SiC doped with 2×10¹⁷ cm⁻³ nitrogen donor atoms at 300 K can satisfy a negative index above 10 GHz radio frequencies.

In an embodiment, semiconductor layer 150 can have a first surface that is adjacent to the dielectric layer 140, and a second surface that is adjacent to waveguide 120. The semiconductor layer 150 can have a thickness selected to stimulate surface plasmon polaritons on either side of the semiconductor surface of the semiconductor layer 150 for EM energy having a given EM wavelength incident on the dielectric layer 140 beyond a critical angle, e.g., an angle of EM incidence at which surface plasmon polaritons are generated after attenuated total internal reflection from the dielectric interface creates evanescent waves.

As the incident angle of the received electromagnetic energy on the outer dielectric surface increases, the amount of energy transmitted into the dielectric medium can decrease and energy from the surface plasmon polaritons can also decrease. When the incident angle on a first dielectric interface, e.g., air/dielectric, increases or extends past 90°, little or no further transmission into the dielectric may occur, although diffraction effects of the aperture may allow it, depending on those effects and the plasmonic design.

In an exemplary embodiment, for sufficiently thin metal films embedded in a dielectric 140, the polaritons associated with the upper and lower metal-dielectric interfaces can couple and form an asymmetric mode tightly bound to the metal film and a symmetric mode in which in the optical domain can extend several micrometers into the upper and lower dielectric via two identical evanescent tails. As thickness of the metal decreases, less energy of the symmetric mode's Long Range Surface Plasmon Polaritons (LR-SPP) can be dissipated into the metal, leading to an increase in propagation length. In the RF domain, propagation lengths can be approximately centimeters to meters. The anti-symmetric mode can also be reduced, due to, for example, propagation loss over travel distance as metal thickness decreases, while propagation length goes up and attenuation goes down as metal thickness decreases for the symmetric mode.

FIG. 1A shows an exemplary embodiment that involves thinning a metal waveguide 120a just before reaching an RF microstrip 160 leading to a microdisk RF-resonator 130.

By way of a non-limiting example, the plasmonic waveguide may be composed of indium antimonide (InSb) with real and imaginary parts of the permittivity given by the following table and derived as shown below and dependent on the value of electron effective mass, em, chosen.

| Real Part in rad, em = 0.067 | Imaginary Part in rad, em = 0.067 |
|---|---|
| −347.1 | 539.6 |
| Real Part in rad, em = 0.014 | Imaginary Part in rad, em = 0.014 |
| −1508.8 | 11201 |

Where real and imaginary parts of permittivity, including the damping term, are given by:

$${ɛ}_{real}^{/} = 1 - \frac{{ω}_{p}^{2}}{( {ω}^{2} + {γ}^{2} )} \\ {ɛ}_{img}^{//} = \frac{γ {ω}_{p}^{2}}{ω ( {ω}^{2} + {γ}^{2} )} \qquad 1.0$$

where ωₚ is plasma frequency, ω is RF frequency and γ is damping frequency. The plasma frequency is given by (in radians):

$${ω}_{p} = {( \frac{{Nq}^{2}}{m {ɛ}_{o}} )}^{1 / 2} \qquad 1.1$$

where N is electron charge density, q is electron charge, m is electron mass and ∈ₒ is free space permittivity. The electron charge density may be inferred using the graph shown below.

The graph shown above can show the maximum electron mobility for pure n-InSb at 77° K as 1.2×10⁶ cm²/Vs; at 300° K 7.7×10⁴ cm²/Vs. This can be 7.7 m²/Vs after conversion to meters²/Vs. For example, the horizontal line drawn for a mobility of 7.7×10⁴ and vertical line drawn for density yields ˜1.8×10¹⁶/cm³ (×1 e⁶ for m³). When compared to known InSb specification sheet values at 77° K: carrier concentration=0.6×10¹⁵ (assumed in cm³); mobility=4×10⁵ (assumed in cm₂/Vs). The inferred charge density may be 30× greater at 300° K than specification values provided at 77° K. Mobility at 77° K can differ by 3×. Note that the specifications may be measured values, which can diverge from the calculated values employed.

Damping can be found by

$$μ = \frac{e τ}{{m}^{*}} \qquad 1.2$$

### Solving for τ

$$τ = \frac{μ {m}^{*}}{e} \qquad 1.3$$

where μ is electron mobility given above as 7.7 m²/Vs, e is electron charge, τ is electron collision time and m* is “effective electron mass” accounting for periodic interactions with atomic voltage fields, given by the electron mass multiplied by 0.0670. The inverse of τ leads to the damping frequency via equation 1.3 and is

$$γ = \frac{1}{τ} = \frac{e}{μ {m}^{*}} \qquad 1.4$$

Material width and thickness may follow standard microstrip design rules or be suitably tuned for the particular application. Thinning of the waveguide for launching RF waves can be designed to accommodate packaging constraints and result in a waveguide thickness approaching zero at the waveguide stage.

In this embodiment, plasmonic modes continue to expand as thickness of the waveguide decreases, i.e., polariton confinement can be released, leading to plane wave propagation supported by the dielectric or a known microstrip 160 that may then route the energy to the disk resonator 130. Hence, the operation can proceed from plasmonic guidance to RF-wave and eventual coupling to the resonator 130. Use of microstrip 160 can allow for suitable placement of an RF MMIC LNA 170.

FIG. 1B shows an exemplary embodiment involving side-coupling of polaritons themselves. Proper separation of the waveguide 120 from resonator 130 can result in nearly total plasmonic coupling to the coupled port, e.g., disk resonator 130. This separation can depend on the materials involved. In the case of coupling to microdisk resonators, the resonators may be made of lithium niobate (LiNbO3), lithium tantalate (LiTaO3) or calcium fluoride (CaF2), for example, each with its own refractive index, and values of electro-optic constants dictating coupling dimensions, sizes and spacing. However, in this embodiment, the microdisk 130 can carry a polariton, not a classical RF field.

Given polariton dispersion relations, a given frequency can have much shorter wavelengths when compared to light at the same frequency. The speed of propagation can also be less. By way of example, plasmonic wavelength relationships can be illustrated by the graph below that shows several dispersion relations as ω (radian frequency) vs. k (wave-number) for light in vacuum as ω=ck; light in some transparent medium with index of refraction n such that ω=ck/n; and that of surface polaritons, where ωₚ is the plasma frequency of electrons in the material. SPPs lie to the right of the freespace light line w=ck, implying that SPPs have shorter wavelengths than light. Since freespace light, ck, and SPP dispersion relations do not intersect, light cannot directly excite (resonate) SPPs, and SPPs cannot spontaneously radiate light (for the free space/smooth metal case). For a given frequency of freespace light, the wavelength is set by c=λf, but for the same given frequency, SPPs have some other λ, and thus do not satisfy c=λf.

Thus, SPPs can feel the effects of both media—dielectric (or vacuum) and metal. The SPP wavelength can then depend on properties of both materials at the interface of interest through the dispersion relation in terms of wavelength given by:

λₛₚ=λ[(∈ₘ+∈_{d})/(∈ₘ∈_{d})]^{1/2} 1.5

Where ∈ is the relative permittivity or dielectric constant in metal, subscript m; or dielectric, subscript d (\sqrt{∈}=n the index of refraction). Equation 1.5 allows for calculation of plasmonic wavelengths for a given material permittivity for both a dielectric layer (subscript d) and metallic or semiconductor (subscript m) and the freespace wavelength of incident electromagnetic radiation λ.

FIG. 1C shows an exemplary embodiment that can include the use of the waveguide 120 as an option for an end-fire coupled method. In an embodiment, the coupling of SPPs can use waveguide 120 that is attached to the feed. The waveguide 120 can efficiently couple the energy into the SPP mode. “Excitation of Surface Polaritons By End-Fire Coupling” by Stegman et al, in Optics Letters, Vol. 8, No. 7, July 1983, although focusing on optical frequencies, provides further background on end-fire coupling and is incorporated herein by reference in its entirety.

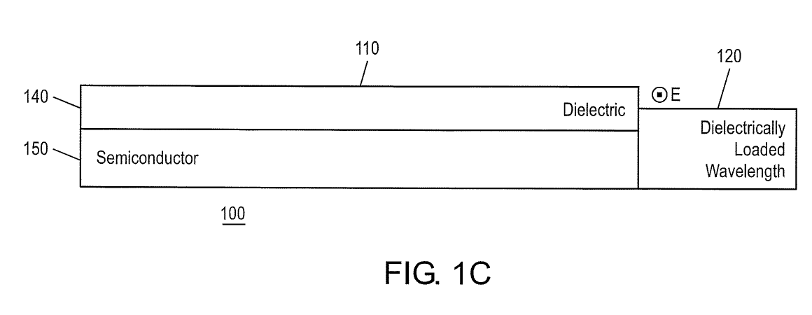

FIG. 2 shows steps in an exemplary polariton waveguide formulation. In an embodiment, waveguides can be fabricated on a silicon wafer spin-coated with a 20 μm thick layer of mr-I T85, for example. The surface can be planarized by embossing with a blank silicon wafer in order to reduce scattering loss caused by surface roughness, for example. Photoresist patterning, gold deposition and lift-off can be used to define straight waveguides with widths ranging from about 3 μm to about 12 μm. Silver, copper, aluminum or suitable semiconductors may also be employed, depending on the application and its frequency of operation where RF frequencies can tend to involve semiconductors while optical frequencies can tend to involve simple metals, such as silver and gold, as determined by the permittivity relations given above and the preference for this permittivity to be suitably negative.

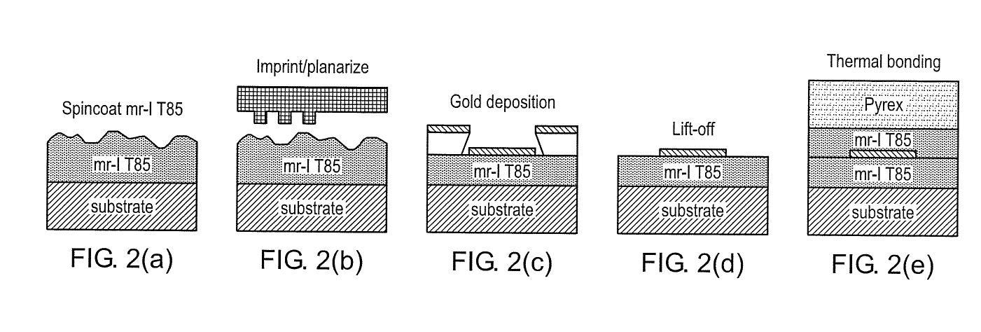

In an exemplary embodiment, the top polymer cladding can be formed by spin-coating a Pyrex wafer with a similar mr-I T85 layer and the two wafers can then be bonded together at 100° C. and 10 kN in a parallel plate embossing machine. The bonded wafers can be diced to different lengths for optical transmission measurements, resulting in the exemplary cross-section shown in FIG. 3. For example, in RF applications, lengths of about 2 inches of InPb can be used to measure plasmon transmission efficiency.

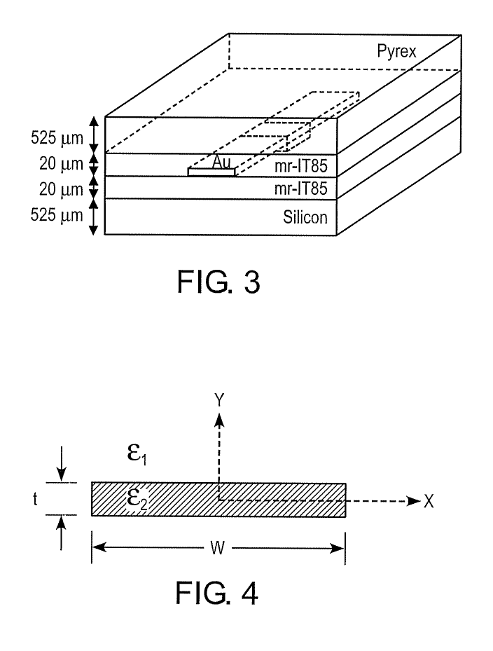

While exemplary embodiments disclosed herein can reduce or eliminate the need for known gratings, the embodiments can still involve transverse-magnetic (TM) polarization, as in devices with gratings, given that polariton waveguides can support this as the dominant mode. For example, TM polarization can be most pronounced when w/t>1, where w (width) and t (thickness) are defined as shown in FIG. 4. TM polarization, in which the magnetic field vector is perpendicular and the electric field vector is parallel to the incident plane, can be used for the surface-featured case of linear gratings that can run perpendicular to the incident plane.

The exemplary methods and devices for plasmonic field guidance disclosed herein can reduce the need for gratings and reduce associated RF-coupling loss while guiding fields in the plasmonic state to their destination, which in an embodiment can be a microdisk RF-resonator.

The embodiments disclosed herein can transfer plasmonic RF from an antenna to a microdisk modulator, convert plasmonic RF to wave state or direct plasmonic coupling to a modulator.

Exemplary embodiments used, for example, in missile seeker applications, can reduce RF losses and thus extend detection range and allow for smaller seeker packaging.

Exemplary embodiments can uses surface plasmon polaritons (SPPs) for power transfer, allow for all-plasmonic coupling and present plasmonic-to-wave-state conversion.

The above description is presented to enable a person skilled in the art to make and use the systems and methods described herein, and is provided in the context of a particular application and its requirements. Various modifications to the embodiments will be readily apparent to those skilled in the art, and the generic principles defined herein may be applied to other embodiments and applications without departing from the spirit and scope of the claims. Thus, there is no intention to be limited to the embodiments shown, but rather to be accorded the widest scope consistent with the principles and features disclosed herein.

What is claimed is:

1. A plasmonic antenna feed and coupling device, comprising:
an antenna; and
a waveguide operatively coupled to the antenna;
wherein surface plasmon polaritons generated on a surface of the antenna are guided in a plasmonic state from the antenna through the waveguide.

2. The plasmonic antenna feed and coupling device of claim 1, comprising:
a microdisk radio frequency resonator operatively coupled to the waveguide.

3. A method of plasmonic field guidance, comprising:
generating surface plasmon polaritons on a surface of an antenna;
guiding the surface plasmon polaritons in a plasmonic state from the antenna to a waveguide; and
coupling the surface plasmon polaritons in a plasmonic state to a port.

4. The method of plasmonic field guidance of claim 3, wherein the port is a microdisk radio frequency resonator.

5. The method of plasmonic field guidance of claim 3, wherein the coupling is by releasing confinement of the surface plasmon polaritons resulting in radio frequency side coupling to the port.

6. The method of plasmonic field guidance of claim 3, wherein the coupling is by side-coupling of the surface plasmon polaritons resulting in plasmonic side coupling to the port.
